(19) United States
(12) Patent Application Publication
(10) Pub. No.: US 2006/0124763 A1
(43) Pub. Date: Jun. 15, 2006

(54) Sliding valve

(76) Inventors: Gernot Hertweck, Fellbach (DE); Katsuyoshi Koyanagi, Esslingen (DK); Holger Kogl, Esslingen (DK); Heinrich Muller, Boppard (DE); Heinz Oing, Fellbach (DK); Gregor Renner, Stuttgart (DK); Marco Stotz, Le-Echterdingen (DE); Jens-Peter Wobbe, Simmental (DE)

Correspondence Address: WILLIAM COLLARD;COLLARD & ROE, P.C., 1077 NORTHERN BOULEVARD, ROSLYN, NY, 11576, US

(21) Appl. No.: 10/540,290

(22) PCT Filed: Nov. 19, 2003
(86) PCT No.: PCT/EP03/12936

§ 371 Date: Dec. 20, 2005

(30) Foreign Application Priority Data
Dec. 20, 2002 (DE) 10261175.0

(51) Int. Cl. F02M 47/02; F02M 63/00; B05B 1/00; F02M 59/00

(52) U.S. Cl. 239/88; 239/89; 239/533.2; 239/602

(57) ABSTRACT

The invention is based on a sliding valve (10) having a sliding sleeve (12) which is axially displaceable in a control cylinder (13) and which controls, with at least one control face (23) on its outer periphery, at least one control opening (17, 18) in the control cylinder (13) out. It is proposed that the control face (23) is radially elastically flexible in the direction of the control cylinder (13).

The invention relates to a sliding valve according to the preamble to claim 1.

From DE 199 16 485 C2, a reciprocating piston internal combustion engine with a fuel injection nozzle is known. This possesses a hollow valve needle having a valve needle head pointing in the direction of a combustion chamber of the internal combustion engine. Between the cavity of the valve needle and its outer periphery, nozzle bores are provided, through which the fuel, in the open state of the injection valve, is injected into the combustion chamber. The injection valve opens by outward displacement of the valve needle in the direction of the combustion chamber, a valve face on the needle head lifting off from a valve seat on a nozzle body. The instantaneous apertural cross section of the nozzle holes is determined in dependence on the needle lift from a control edge on the inner margin of the valve seat of the nozzle body.

The injection valve possesses two rows of controllable nozzle holes, which are disposed mutually offset in the motional direction of the valve needle. The nozzle holes of the one row differ from the nozzle holes of the other row in their inclination to the nozzle axis and in their cross-sectional shape, so that the mixture formation in the combustion chamber can be adapted within wide ranges to the operating parameters. The fuel injection valve is a combination of a seat valve, whereby, in the closed state, a subsequent dripping of the injection nozzle is prevented, and a sliding valve, whereby the injection quantity and fuel preparation can be varied. Owing to the nozzle bores in the valve needle, the walls of the valve needles must have an adequate thickness. Furthermore, the valve needle head increases the mass of the valve, so that, apart from the complexity of the injection nozzle resulting from the combination of two control mechanisms, the needle control and actuator system, owing to the mass of the nozzle needle, is very complex and can lead to switching noises. Moreover, such a system is not possible for injection nozzles having inward-opening nozzle needles.

From DE 100 10 863 A1, an inward-opening injection nozzle is known, likewise having two rows of nozzle bores, which are made in the nozzle body and are opened and closed by two nozzle needles disposed coaxially to one another and having corresponding end-face seat faces.

The object of the invention is to simplify a tight-closing sliding valve and to reduce the mass of the moving parts. This is achieved according to the invention by the features of claim 1. Further advantageous embodiments emerge from the subclaims.

According to the invention, the control face on the sliding sleeve is radially elastically flexible in the direction of the control cylinder. It is hence able to tightly close off the control openings in the closed state, without the high production cost of tight fits. In this context, it is advantageous that the control faces bear against the control cylinder under a predetermined preload, or are forced against the control cylinder by the pressure of a controlled medium, a gas or a liquid. Since the contact pressure rises with increasing medium pressure, the sliding valve forms a secure seal even when the medium pressures are high.

Since, in a fuel injection valve, the medium, namely the fuel, is fed through the cavity of the valve needle and of the sliding sleeve under high pressure, such a sliding valve is particularly suitable as a fuel injection valve, though it is equally suitable for other applications and for controlling gaseous media. The sliding valve according to the invention is distinguished, above all, by a simple construction, freedom from leaks and of a low mass of the moving parts, thereby reducing the cost of the control and actuator system while maintaining short response times. In addition, switching noises are prevented.

The elasticity in the radial direction can be produced by the thin-walled sliding sleeve being of membrane-like construction in the region of the control faces, or by the control face being disposed on resiliently flexible parts of the sliding sleeve. According to one embodiment of the invention, the sliding sleeve has at least one longitudinal slot, so that the control face can yield in the radial direction. If a plurality of control faces, distributed over the periphery, are assigned to a plurality of control openings, a corresponding number of longitudinal slots are provided, which form between them spring tongues, on which the control faces are disposed. If the longitudinal slots are extended up to the end face of the sliding sleeve, it is advantageous to dispose the control faces at the end of the spring tongues which are thus formed. The geometric shaping of the spring tongues enables their spring characteristics to be influenced and to be tailored to the particular application.

Expediently, the spring tongues are reinforced in the region of the control faces. The control faces thereby acquire adequate dimensional stability, so that they can lie tightly against the control openings.

In order to facilitate the fitting of the sliding valve, it is expediently realized in cartridge construction. Furthermore, the sliding sleeve can be made of magnetically conductive material and its top part can simultaneously serve as the armature of a magnetic circuit. A simplified, compact-built actuator system is thereby achieved.

To enable the control faces of the sliding sleeve to be clearly assigned to the control openings, it is expedient to prevent the sliding sleeve from twisting during its axial motion or to guide it forcefully in the rotational direction. This can be done, for example, by the sliding sleeve, or a part connected thereto, having a cross sectional profile which varies from the circular form and which is guided in a suitable guide of the valve body. Such a profile could be, for example, a polygonal profile. The sliding sleeve could also be guided in a coarse thread.

Further advantages emerge from the following description of the drawing. In the drawing, an illustrative embodiment of the invention is represented. The drawing, the description and the claims contain numerous features in combination. Expediently, the person skilled in the art will also view the features individually and will put them together into sensible further combinations.

In the drawing:

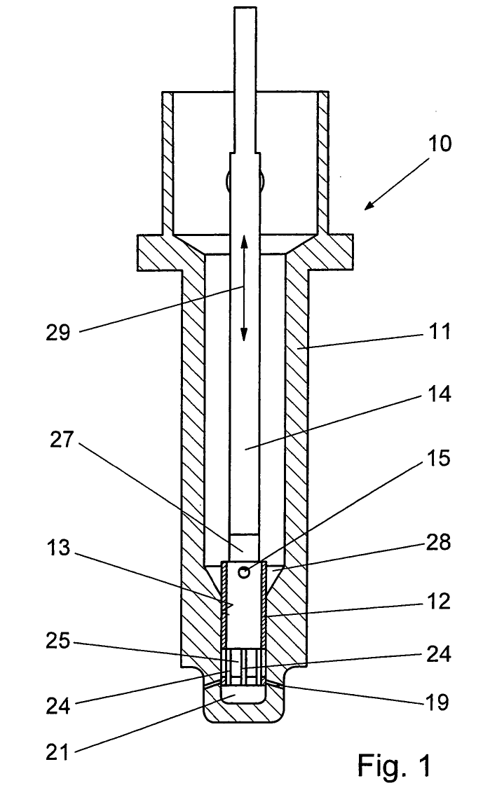

FIG. 1 shows a diagrammatic longitudinal section through a sliding valve according to the invention, and

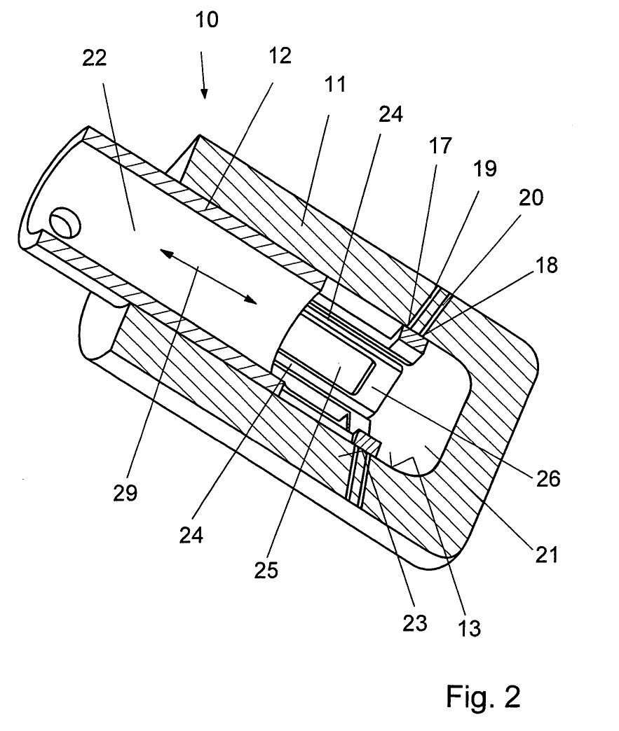

FIG. 2 shows a perspective detail enlargement of an embodiment according to FIG. 1, having two rows of nozzle bores.

A sliding valve 10 in the form of a fuel injection valve for an internal combustion engine possesses a valve housing 11, in which a sliding sleeve 12 is guided in a control cylinder 13 such that it is axially displaceable in the motional direction 29. The sliding sleeve 12 is connected by a cross pin 15, which is inserted in a transverse bore 16 in the sliding sleeve 12, to a valve rod 14. The latter is actuated by an actuator system (not represented in greater detail), e.g. by an electromagnet. The sliding sleeve 12 and its upper part 27 can be made here of magnetic material and can be configured as a magnet armature.

The sliding sleeve 12 has, originating from its free end, longitudinal slots 24, which are distributed over the periphery and form between them spring tongues 25, at the ends of which, on the outer periphery, control faces 23 are disposed, which cooperate with control openings 17, 18 in the control cylinder 13. The control openings 17, 18 are adjoined by outwardly directed nozzle bores 19, 20. These are disposed mutually offset in the motional direction 29 of the sliding sleeve 12. In the closed state of the sliding valve 10, the control faces 23 cover the control openings 17, 18. A control face 23 can interact here with one or more control openings 17, 18. Through the motion of the sliding sleeve 12 in one direction, the corresponding control opening 17 or 18 is first opened up, and, upon a further adjustment sliding sleeve 12, the control opening 17 or 18 which had previously remained closed. The sliding sleeve 12 can thus more or less open a plurality of control openings 17 or 18, alternately or successively.

In the region 26 of the control faces 23, the spring tongues 25 are reinforced, so that, as a result of the increased dimensional stability, the control faces 23 bear tight against the control openings 17, 18 and close these off in a leak-free manner. The pressure with which the control faces 23 bear against the control openings 17, 18 can be achieved by a certain preloading of the spring tongues 25 or through the pressure of the medium to be controlled. This medium is fed centrally through a cavity 22 of the sliding sleeve 12 and is conveyed through the nozzle bores 19, 20. The control cylinder 13 terminates at the end face with the blind hole 21. Expediently, the spring tongues 25 are pre-bent outward by a predefined amount. In addition, the spring characteristics can be determined by the choice of material and the geometric shaping. To enable the sliding sleeve to be easily fitted, the valve housing 11 possesses, in the direction of the control cylinder 13, a conical region 28, by which the spring tongues 25 are forced back to the measure of the control cylinder 13.

The embodiment according to FIG. 2, which essentially represents a detail of FIG. 1 on an enlarged scale, shows two rows of nozzle bores 19, 20, which are disposed mutually offset in the motional direction 29 and/or in the peripheral direction. The nozzle bores 19, 20 can have a different inclination to the motional direction 29 and can additionally possess different cross-sectional profiles, as is known, per se, in respect of fuel injection valves of the type mentioned in the introduction.

1-13. (canceled)

14. A sliding valve having a sliding sleeve which is axially displaceable in a control cylinder and which controls, with at least one control face on its outer periphery, at least one control opening in the control cylinder, the control face (23) being radially elastically flexible in the direction of the control cylinder (13) and bearing against the control cylinder (13), wherein the sliding sleeve (12), in the region of the control face (23), has at least one longitudinal slot (24).

15. The sliding valve as claimed in claim 14, wherein a plurality of longitudinal slots (24) are provided, which form between them spring tongues (25), on which the control faces (23) are disposed.

16. The sliding valve as claimed in claim 15, wherein the spring tongues (25) are reinforced in the region (26) of the control faces (23).

17. The sliding valve as claimed in claim 14, wherein the control face (23) is forced against the control cylinder (13) by the pressure of a controlled medium.

18. The sliding valve as claimed in claim 14, wherein it is realized in cartridge construction.

19. The sliding valve as claimed in claim 14, wherein the sliding sleeve (12) is made of magnetically conductive material and its top part (27) simultaneously serves as the armature of a magnetic circuit.

20. The sliding valve as claimed in claim 14, wherein the sliding sleeve (12) is guided in the control cylinder (13) in a torsionally secure manner.

21. The sliding valve as claimed in claim 14, wherein the control cylinder (13) has a conical region (28) for the threading of the sliding sleeve (12).

22. The sliding valve as claimed in claim 14, wherein it is a fuel injection valve for an internal combustion engine.

23. The sliding valve as claimed in claim 14, wherein in the control cylinder (13) there are provided at least two axially offset control openings (17, 18), having adjoining nozzle bores (19, 20).

24. The sliding valve as claimed in claim 23, wherein at least two nozzle bores (19, 20) differ in relation to their position and/or shape.
